(19) United States
(12) Patent Application Publication
(10) Pub. No.: US 2024/0306846 A1
(43) Pub. Date: Sep. 19, 2024

(54) MODULAR AIR FRYER

(71) Applicant: The Steelstone Group LLC, Brooklyn, NY (US)

(72) Inventors: Naphtali H. Biegeleisen, Brooklyn, NY (US); Binyumen Itzkowitz, Brooklyn, NY (US); Meilech Friedman, Brooklyn, NY (US); Kalman Wertzberger, Brooklyn, NY (US); Robyn De Luca, Queens, NY (US); Wenhui Huang, Brooklyn, NY (US); Joseph Deutsch, Brooklyn, NY (US)

(21) Appl. No.: 18/436,657

(22) Filed: Feb. 8, 2024

Related U.S. Application Data
(60) Provisional application No. 63/452,306, filed on Mar. 15, 2023.

(51) Int. Cl. A47J 37/06; A47J 36/02; A47J 36/04

(52) U.S. Cl. CPC A47J 37/0641; A47J 36/02; A47J 36/04; A47J 37/0664

(57) ABSTRACT

An air fryer assembly is provided including a functional module having a heating element and an airflow generator and a cooking compartment module having an upper end providing access to an internal cooking chamber. The functional module has a fixation end for fixing the functional module to the upper end of the cooking compartment module, and the functional module generates a flow of heated air within the internal cooking chamber by way of the airflow generator and the heating element.

### CROSS-REFERENCE TO RELATED APPLICATIONS

This application takes priority from U.S. Provisional Patent Application No. 63/452,306, filed Mar. 15, 2023, the contents of which are incorporated by reference herein.

### FIELD OF THE INVENTION

The present disclosure generally relates to an air fryer, namely a modular or portable air fryer.

### BACKGROUND

Air fryer cooking appliances are used to reduce the quantity of fat used to cook foods of plant or animal origin, such as French fries, vegetables, meat, or fish. The use of an air fryer typically replaces the use of a deep fryer or other oil-based cooking method. The cooking takes place with little or no oil because of the hot air circulating inside the fryer, making it possible to eat healthier foods that are crisp on the outside and soft on the inside.

Air fryers typically comprise large housings that can provide internal chambers with controlled airflow. In such devices, a drawer or basket for food is usually provided for insertion into the internal chamber, and components within the large housing heats air and controls circulation of hot air within the drawer or basket. Often, a mesh basket is provided to allow for air circulating through the basket during use. However, such a structure requires a large footprint, and typically the size of such a structure cannot be reduced for storage, shipping, or travel.

There is a need for an air fryer that can be made smaller when not in use.

### SUMMARY

An air fryer assembly is provided including a functional module having a heating element and an airflow generator and a cooking compartment module having an upper end providing access to an internal cooking chamber. The functional module has a fixation end for fixing the functional module to the upper end of the cooking compartment module, and the functional module generates a flow of heated air within the internal cooking chamber by way of the airflow generator and the heating element.

In some embodiments, a boundary of the fixation end of the functional module is sized to substantially correspond to the open upper end of the cooking compartment module. A boundary of a second end of the functional module opposite the fixation end is smaller than the boundary of the fixation end, such that when inverted, the second end of the functional module fits at least partially inside the internal cooking chamber. In some such embodiments, a majority of the functional module fits inside the internal cooking chamber of the cooking compartment module.

In some embodiments, the cooking compartment module comprises an outer housing and an inner cooking container having the internal cooking chamber, the inner cooking container being movable relative to the outer housing. The functional module then fixes to the outer housing and not the inner cooking container.

In some such embodiments, the inner cooking container is translatable relative to the outer housing while the functional module is fixed to the outer housing.

In some such embodiments, the inner cooking container further includes a handle for pulling the inner cooking container out of the outer housing in the direction in which the inner cooking container translates.

In some such embodiments, the air fryer assembly further includes an obstruction for limiting the translation of the inner cooking container, such that when contacting the obstruction, the internal cooking chamber of the inner cooking container is positioned adjacent the functional module.

In some embodiments, the functional module further includes a gasket for sealing an opening of the inner cooking container.

In some embodiments, the outer housing is formed from or comprises plastic and the inner cooking container is formed from or comprises glass.

In some embodiments, the outer housing is formed from or comprises plastic and the inner cooking container is formed from or comprises metal.

In some embodiments, the functional module further comprises a power cord for providing power to the heater and airflow generator, and an internal chamber for receiving the power cord for storage.

In some embodiments, the airflow generator is a fan.

In some embodiments, the heating element is a resistor positioned in the path of airflow generated by the airflow generator.

In some embodiments, the air fryer assembly includes a removable rack for holding food within the cooking compartment module.

In some embodiments, the functional module includes a user interface for controlling the heating element and airflow generator.

In some embodiments, the cooking compartment module is passive and any electrical components of the assembly are contained within the functional module.

### BRIEF DESCRIPTION OF THE DRAWINGS

FIG. 1 is an embodiment of a modular air fryer in accordance with this disclosure.

FIG. 2 is a side view of the modular air fryer of FIG. 1.

FIG. 3 is a second embodiment of a modular air fryer in accordance with this disclosure.

FIG. 4 is a side view of the modular air fryer of FIG. 3.

FIG. 5 is partially disassembled view of the modular air fryer of FIG. 3.

FIG. 6 is the modular air fryer of FIG. 3 being positioned for storage.

FIG. 7 is the modular air fryer of FIG. 3 in a storage configuration.

FIG. 8 is a third embodiment of a modular air fryer in accordance with this disclosure.

FIG. 9 is a back perspective view of the modular air fryer of FIG. 8.

FIG. 10 is a side view of the modular air fryer of FIG. 8.

FIG. 11 is a back view of the modular air fryer of FIG. 8.

FIG. 12 is a partially exploded view of the modular air fryer of FIG. 8.

FIG. 13 is the modular air fryer of FIG. 8 shown in an open configuration.

FIG. 14 is a sectioned view of the modular air fryer of FIG. 8.

FIG. 15 is a sectioned view of the modular air fryer of FIG. 8 illustrating airflow within the air fryer.

### DETAILED DESCRIPTION OF THE PREFERRED EMBODIMENTS

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

It is important to note that the embodiments disclosed are only examples of the many advantageous uses of the innovative teachings herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality.

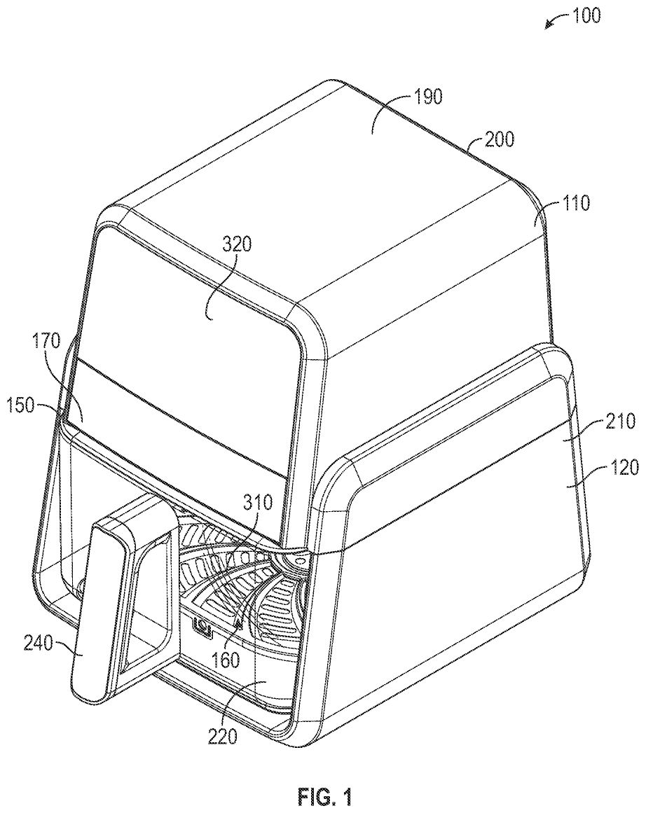

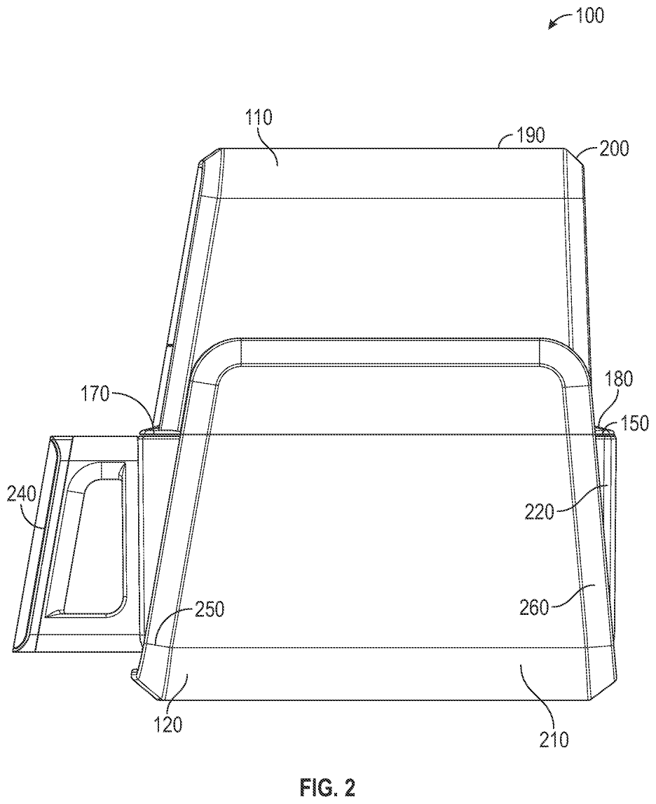

FIG. 1 is an embodiment of a modular air fryer 100 in accordance with this disclosure. FIG. 2 is a side view of the modular air fryer 100 of FIG. 1.

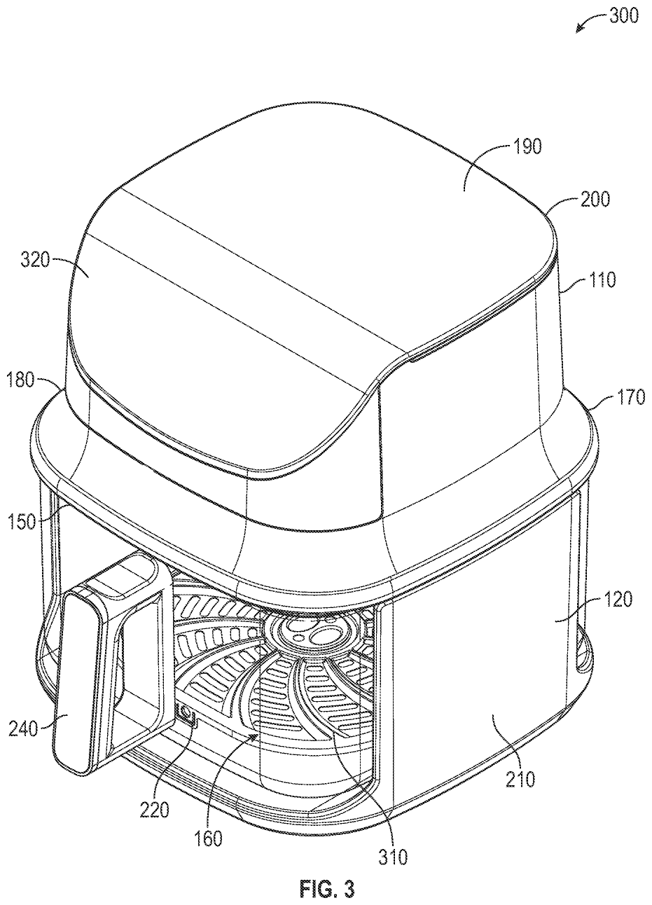

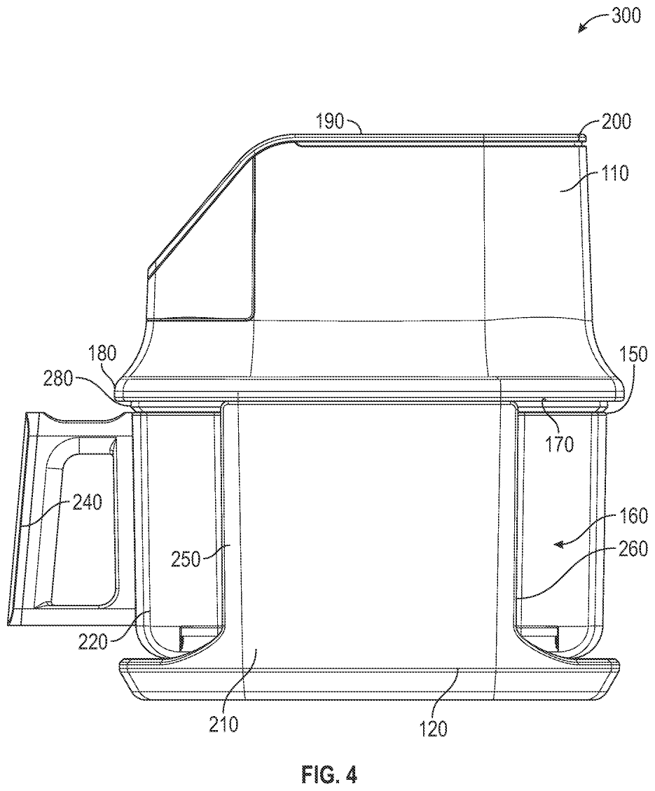

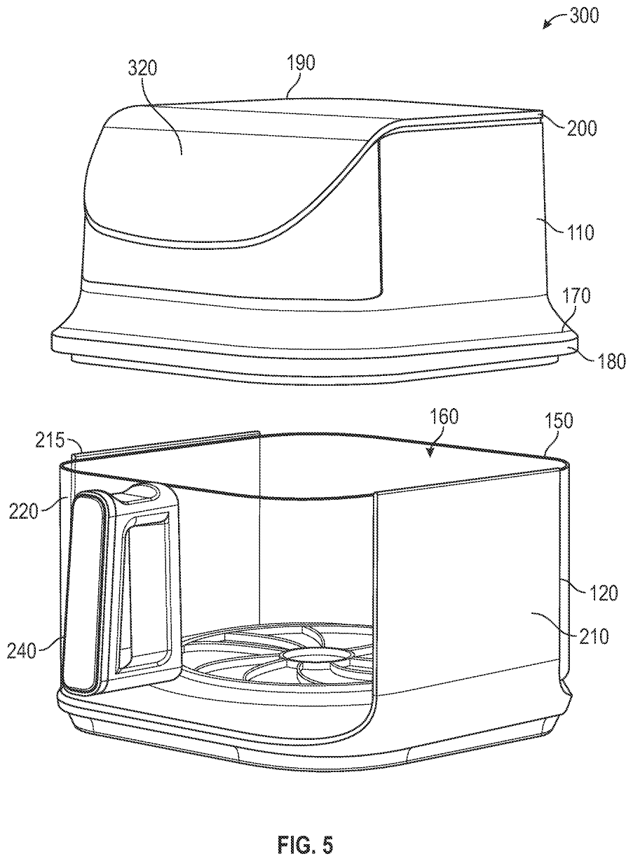

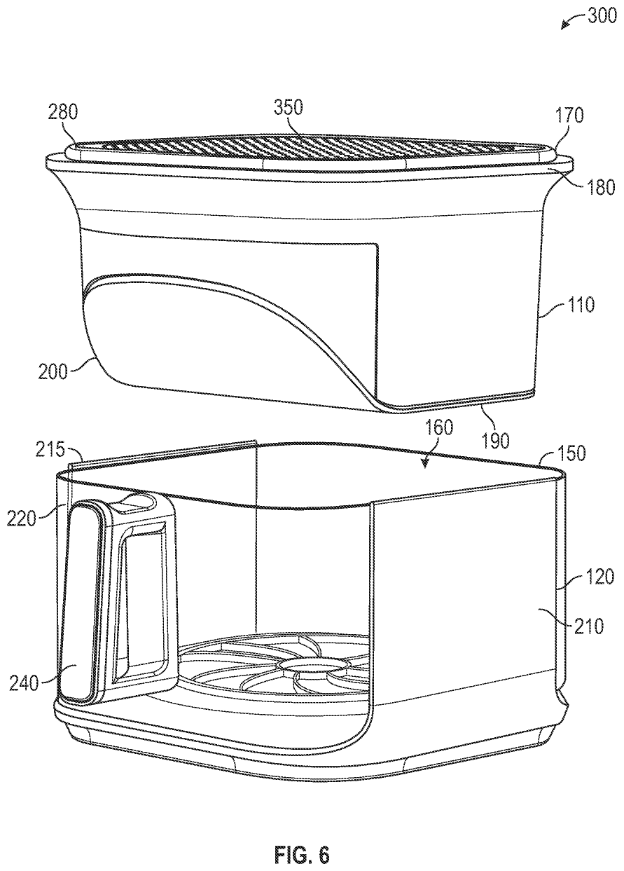

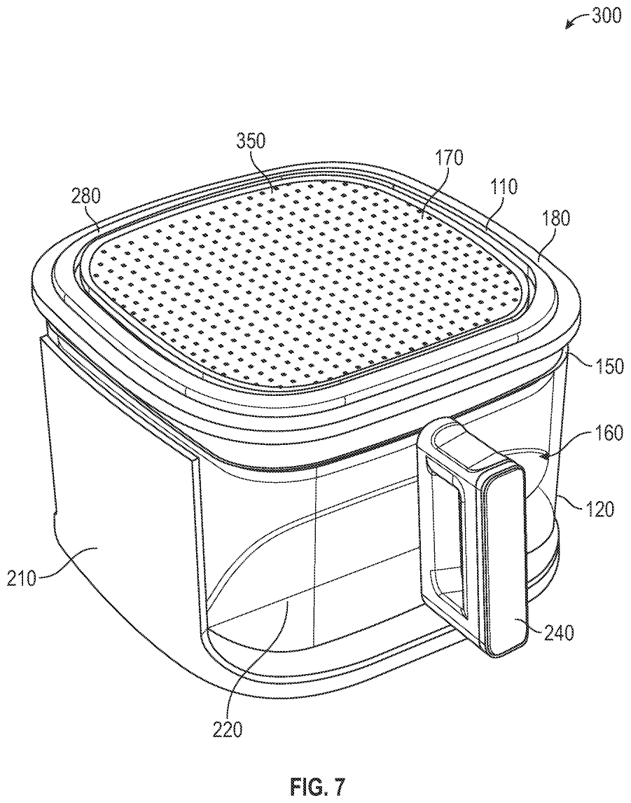

FIG. 3 is a second embodiment of a modular air fryer 300 in accordance with this disclosure. FIG. 4 is a side view of the modular air fryer 300 of FIG. 3. FIG. 5 is partially disassembled view of the modular air fryer 300 of FIG. 3. FIG. 6 is the modular air fryer 300 of FIG. 3 being positioned for storage. FIG. 7 is the modular air fryer 300 of FIG. 3 in a storage configuration.

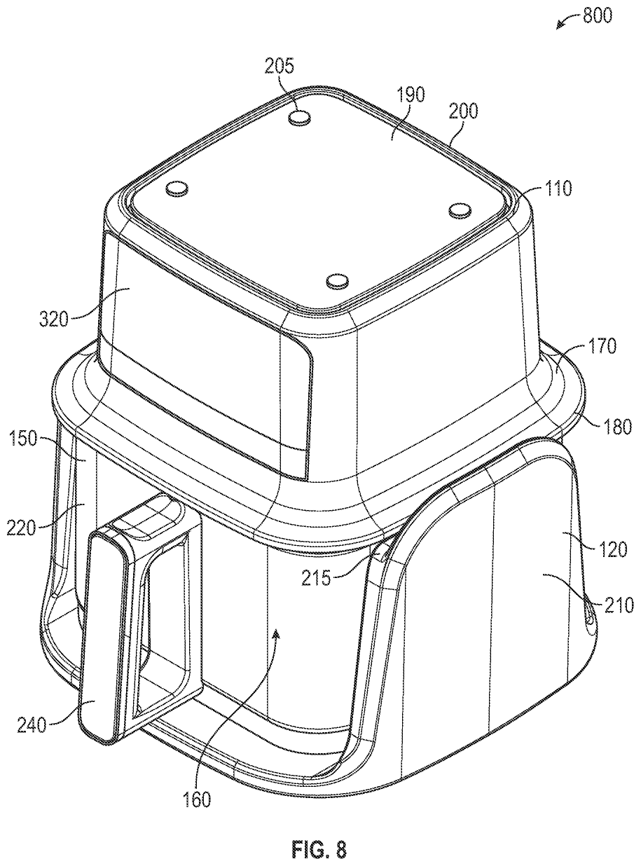

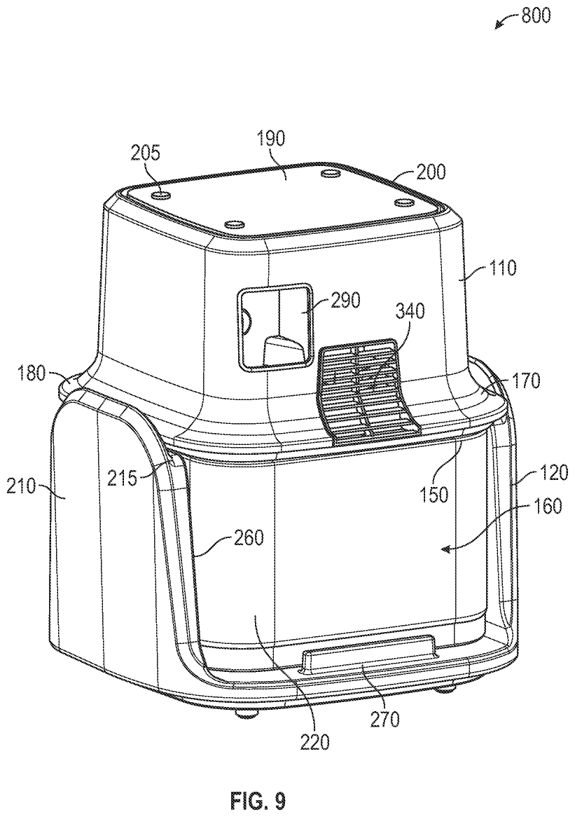

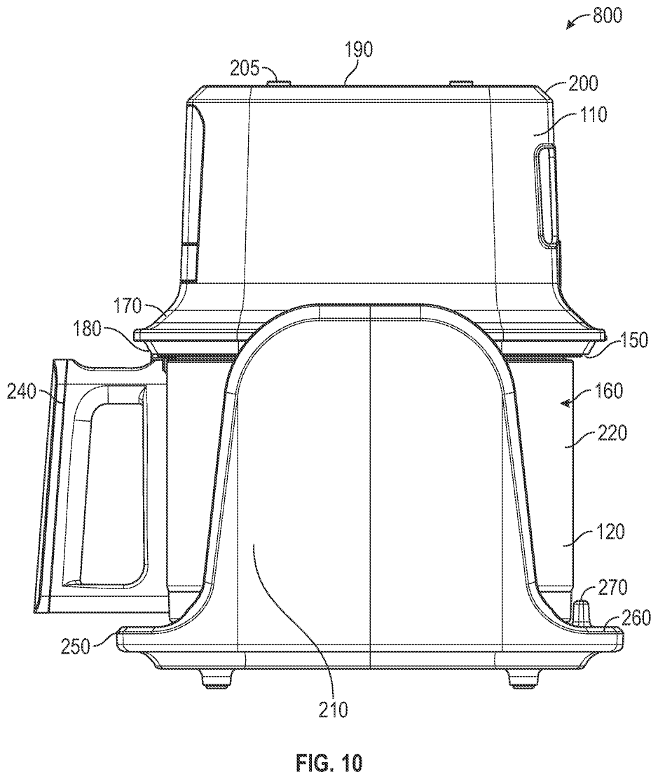

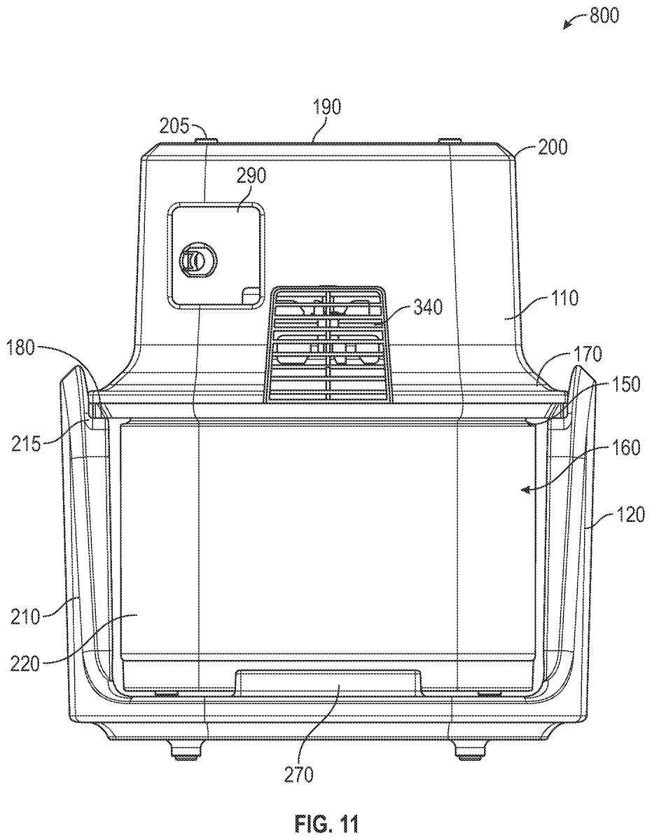

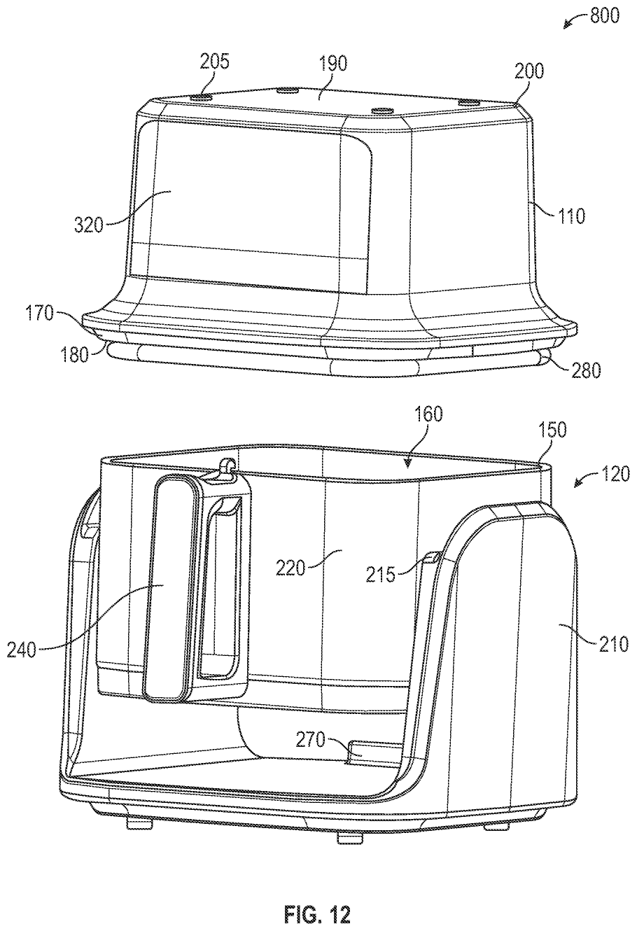

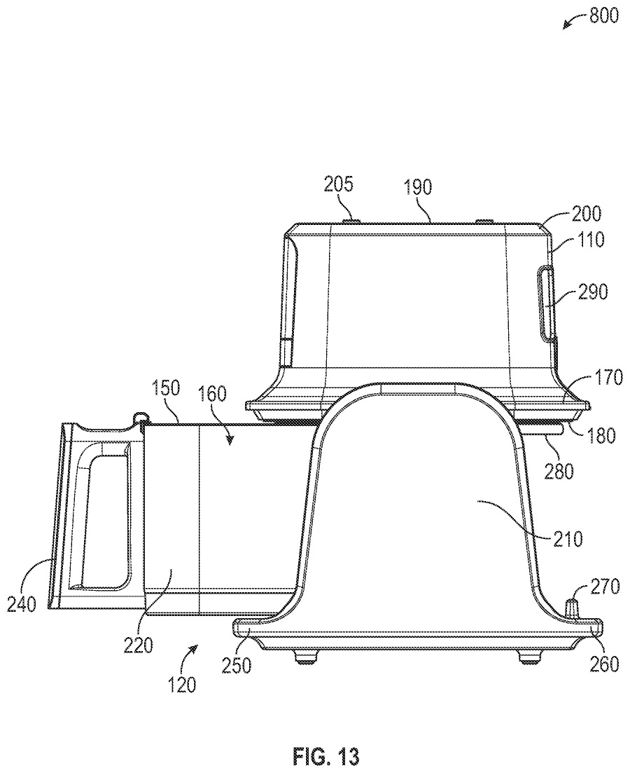

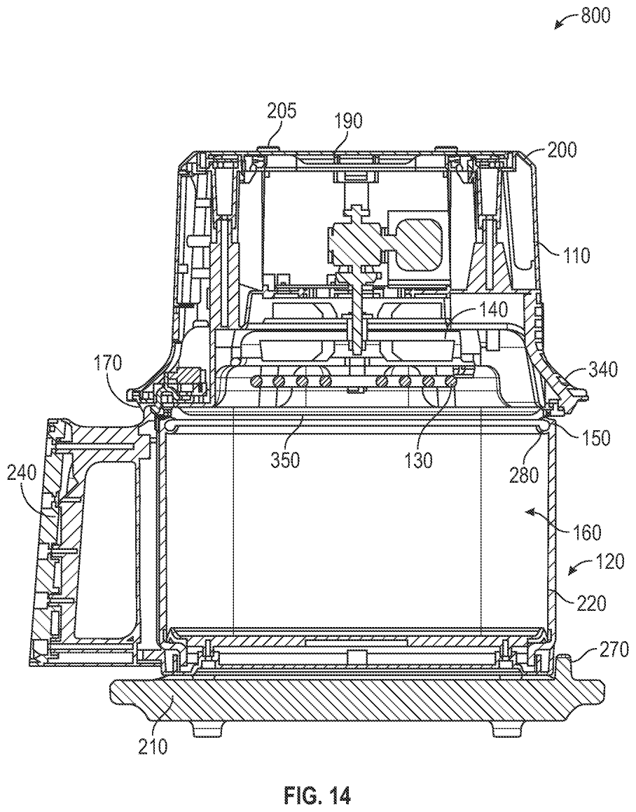

FIG. 8 is a third embodiment of a modular air fryer 800 in accordance with this disclosure. FIG. 9 is a back perspective view of the modular air fryer 800 of FIG. 8. FIG. 10 is a side view of the modular air fryer 800 of FIG. 8. FIG. 11 is a back view of the modular air fryer 800 of FIG. 8. FIG. 12 is a partially exploded view of the modular air fryer 800 of FIG. 8. FIG. 13 is the modular air fryer 800 of FIG. 8 shown in an open configuration. FIG. 14 is a sectioned view of the modular air fryer 800 of FIG. 8.

All three embodiments of the air fryer 100, 300, 800 discussed herein contain similar components. As such, in the discussion that follows, a reference to the air fryer 100 would typically also apply to the other embodiments of the air fryers 300, 800, and components discussed herein are typically consistent across the three embodiments, unless otherwise noted.

As shown, the air fryers 100 discussed herein are typically provided as air fryer assemblies, as they are modular and are assembled for usage. The air fryer 100 typically comprises a functional module 110 and a cooking compartment module 120. As shown in the section view of FIG. 14, the functional module 110 has a heating element 130 and an airflow generator 140. The functional module 110 is then separable from the cooking compartment module 120, such that the air fryer assembly 100 can be reconfigured for convenient storage, as discussed in more detail below.

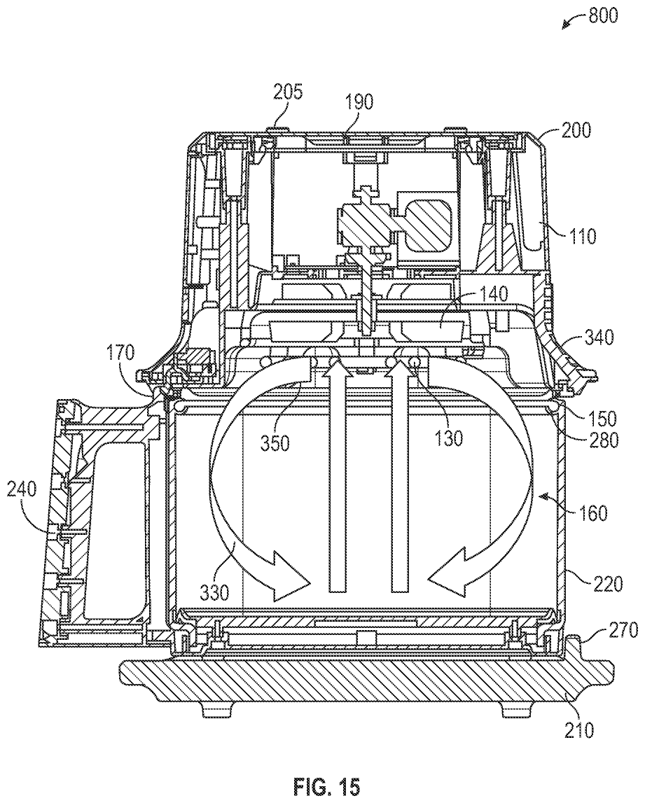

The cooking compartment module 120 has an open upper end 150 which provides access to an internal cooking chamber 160. The functional module 110 has a fixation end 170 for fixing to the open upper end 150 of the cooking compartment module 120. When assembled and in use, the functional module 110 generates a flow of heated air within the internal cooking chamber 160 by way of the airflow generator 140 and the heating element 130 as shown in FIG. 15.

The fixation end 170 of the functional module 110 has a boundary 180 which mates with the open upper end 150 of the cooking compartment module 120. The boundary 180 of the fixation end 170 is then sized to substantially correspond to the open upper end 150 of the cooking compartment module 120.

The functional module 110 also has a second end 190 opposite the fixation end 170, and a boundary 200 of the second end is smaller than the boundary 180 of the fixation end. Accordingly, when inverted, as shown in FIG. 6, the functional module 110 fits at least partially inside the internal cooking chamber 160. While the functional module 110 can be sized in various ways, any amount of the functional module that can fit within the internal cooking chamber 160 reduces the space needed for storage or transport of the air fryer 100. Accordingly, the functional module 110 may be provided with a taper, and the degree of taper combined with the size of the boundary 180 of the fixation end may combine to define how much of the functional module 110 fits inside of the internal cooking chamber 160.

As such, in a typical embodiment, as shown in FIG. 7, a majority of the functional module 110 fits inside the internal cooking chamber 160 of the cooking compartment module 120 when in a storage configuration. A storage configuration, such as that shown in FIG. 7, may be utilized during initial sales, such that the air fryer assembly 100 can be packed in a smaller box, allowing for more efficient bulk shipment.

As shown, in some embodiments, the second end 190 of the functional module may include feet 205. Such feet 205 may be molded into the housing of the functional module 110 in some embodiments. Alternatively, the feet 205 may be formed from a different material and may be, for example, rubberized or otherwise distinct from the material of the rest of the housing of the functional module 110. In such embodiments, when the functional module 110 is partially inside the internal cooking chamber 150 as in the described storage configuration, the meet 205 may support the functional module on a floor of internal cooking chamber 160 of the cooking compartment module 120.

In the embodiments shown, the cooking compartment module 120 may include an outer hosing 210 and an inner cooking container 220, or basket. As shown, in some embodiments, the outer housing 210 may not fully enclose the cooking container 220. Instead, the outer housing 210 may function as a frame for supporting and locating the functional module 110 relative to the inner cooking container 220. The outer housing 210 may then contain a retaining element 215, such as a shelf or bracket, for supporting the functional module 110.

In such an embodiment, the inner cooking container 220 includes the internal cooking chamber 160. The outer housing 210 and the inner cooking container 220 may be formed from different materials. For example, the outer housing 210 may be formed from plastic, while the inner cooking container 220 is formed from glass. Alternatively, the inner cooking container 220 may be formed from metal, ceramic, or other materials. Both materials may be heat resistant or heatproof.

Where the inner cooking container 220 is a separate component than the outer housing 210, the functional module 110 is typically fixed to the outer housing 210 at at least one retaining element 215. The functional module 110 is then not attached to the inner cooking container 220. During use, the inner cooking container 220 may then be translatable relative to the outer housing 210, while the functional module 110 remains in place fixed to the outer housing. This is shown, for example, in FIG. 13. In this way, the inner cooking container 220 may be equivalent to a removable cooking basket in a traditional air fryer.

The inner cooking container 220 may further provide a handle 240, and such a handle may allow for a user to pull the inner cooking container 220 out of the outer housing 210 in the direction in which the inner cooking container translates. In this way, the inner cooking container 220 can be pulled out of the outer housing 210 to an open configuration as shown in FIG. 13. In some embodiments, the inner cooking container 220 may be pulled entirely out of the outer housing 210.

In the embodiment shown, the outer housing 210 supports the functional module 110 on two sides, and as such, when the air fryer assembly 100 is assembled, the assembly is open on a front side 250 and a back side 260. However, while the inner cooking container 220 is designed to translate forward towards the front side 250, it may be undesirable for the inner cooking container to translate backwards towards the back side 260. As such, the air fryer assembly 100 may further include an obstruction 270 for limiting the translation of the inner cooking container 220 in the backwards direction. When the inner cooking container 220 contacts the obstruction 270, which functions as a stop, the inner cooking container may then be at the end of its travel, and the internal cooking chamber 160 may then be positioned adjacent the functional module 110.

In some embodiments, the outer housing 210 may take a different form, and may therefore not require such an obstruction 270. For example, the outer housing 210 may be further provided with a back wall.

In the embodiment shown, the functional module 110 may further comprise a gasket 280 for sealing an opening of the inner cooking container 220. Such an opening may be the same as the open upper end 150 of the cooking compartment module 120, for example. Accordingly, when positioned within the outer housing 210, the functional module 110 may be at least partially sealed to the inner cooking container 220 by way of the gasket 280. It is noted that the gasket 280 may extend slightly below the fixation end 170 of the functional module 110. As such, the gasket 280 may abut or extend slightly into the inner cooking container 220. The gasket 280 may then be provided with sufficient flexibility to flex out of the way when the inner cooking container 220 is translated out of the outer housing 210. The gasket may be formed from a soft and resilient material, such as silicone.

Typically, the functional module 110 includes all electronic components, and as such requires a power supply. In some embodiments, a cavity 290 may be provided in the functional module 110 for accepting a power cable. Such a power cable (not shown) may be fixed within the cavity only during use, or it may be permanently fixed in place. In either case, the power cable may be stored within the cavity 290 provided.

In some embodiments, the air fryer assembly 100 may further include a removable rack 310 for holding food within the cooking compartment module 120. Further, as shown, the functional module 110 may be provided with a user interface 320, such as a touch screen and/or digital display, for controlling the heating element 130 and airflow generator 140.

FIG. 15 is a sectioned view of the modular air fryer of FIG. 8 illustrating airflow within the air fryer 100, 300, 800. As shown, in some embodiments, the airflow generator 140 may be a fan. The heating element 130 may be a resistor positioned in the path of airflow generated by the airflow generator 140.

During use, in some embodiments, the airflow 330 in the internal cooking chamber 160 is circulated by the centrifugal fan 140. Such airflow 330, is shown conceptually in FIG. 15. Typically, the air is circulated, and over the course of cooking fresh air is sucked into the chamber as hot air is exhausted and pressure equilibrates. Such movement may be a suction effect, and it may be a function of air being exhausted through a vent 340. Other air flow schematics may be possible as well.

In order to allow for airflow 330 between the functional module 110 and the internal cooking chamber 160, a bottom surface 350 of the functional module 110 may be porous or may otherwise allow for airflow between the modules.

The air fryer assembly 100 may be designed such that any electrical components, such as the heating element 130 and the airflow generator 140 as well as the user interface 320 and any circuitry linking the user interface to other components and regulating the functioning of the assembly, are contained within the functional module 110. In this way, the cooking compartment module 120 may be passive and no electrical connection is necessary between the two. Accordingly, any link or retaining element unifying the functional module 110 and the cooking compartment module 120 during use may be purely mechanical.

Alternatively, in some embodiments, at least some electrical connection or detection mechanism may be provided so as to confirm the presence of the cooking compartment module 120 prior to activating the functional module 110. This may be by providing electrical contacts that can then complete a circuit, or it may be by providing a pressure switch confirming an expected seating of the functional module 110 at a corresponding retaining element 215.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An air fryer assembly comprising:
a functional module having a heating element and an airflow generator; and
a cooking compartment module having an open upper end providing access to an internal cooking chamber,
wherein the functional module has a fixation end for fixing the functional module to the open upper end of the cooking compartment module, and
wherein the functional module generates a flow of heated air within the internal cooking chamber by way of the airflow generator and the heating element.

2. The air fryer assembly of claim 1, wherein a boundary of the fixation end of the functional module is sized to substantially correspond to the open upper end of the cooking compartment module, and wherein a boundary of a second end of the functional module opposite the fixation end is smaller than the boundary of the fixation end, such that when inverted, the second end of the functional module fits at least partially inside the internal cooking chamber.

3. The air fryer assembly of claim 2, wherein a majority of the functional module fits inside the internal cooking chamber of the cooking compartment module.

4. The air fryer assembly of claim 1, wherein the cooking compartment module comprises an outer housing and an inner cooking container having the internal cooking chamber, the inner cooking container being movable relative to the outer housing, and wherein the functional module fixes to the outer housing and not the inner cooking container.

5. The air fryer assembly of claim 4, wherein the inner cooking container is translatable relative to the outer housing while the functional module is fixed to the outer housing.

6. The air fryer assembly of claim 5, wherein the inner cooking container further comprises a handle for pulling the inner cooking container out of the outer housing in the direction in which the inner cooking container translates.

7. The air fryer assembly of claim 6 further comprising an obstruction for limiting the translation of the inner cooking container, such that when contacting the obstruction, the internal cooking chamber of the inner cooking container is positioned adjacent the functional module.

8. The air fryer assembly of claim 4 wherein the functional module further comprises a gasket for sealing an opening of the inner cooking container.

9. The air fryer assembly of claim 4 wherein the outer housing comprises plastic and the inner cooking container comprises glass.

10. The air fryer assembly of claim 4 wherein the outer housing comprises plastic and the inner cooking container comprises metal.

11. The air fryer assembly of claim 1, wherein the functional module further comprises a power cord for providing power to the heater and airflow generator, and an internal chamber for receiving the power cord for storage.

12. The air fryer assembly of claim 1, wherein the airflow generator is a fan.

13. The air fryer assembly of claim 1, wherein the heating element is a resistor positioned in the path of airflow generated by the airflow generator.

14. The air fryer assembly of claim 1 further comprising a removable rack for holding food within the cooking compartment module.

15. The air fryer assembly of claim 1, wherein the functional module further comprises a user interface for controlling the heating element and airflow generator.

16. The air fryer assembly of claim 1, wherein the cooking compartment module is passive and any electrical components of the assembly are contained within the functional module.
